(19) United States
(12) Patent Application Publication
(10) Pub. No.: US 2020/0141436 A1
(43) Pub. Date: May 7, 2020

(54) PUSH-PIN RIVET FASTENER

(71) Applicant: Zephyros, Inc., Romeo, MI (US)

(72) Inventor: Kyle Deachin, Romeo, MI (US)

(21) Appl. No.: 16/675,767

(22) Filed: Nov. 6, 2019

Related U.S. Application Data
(60) Provisional application No. 62/756,352, filed on Nov. 6, 2018.

(51) Int. Cl. F16B 19/00

(52) U.S. Cl. CPC F16B 19/004

(57) ABSTRACT

A push-pin rivet fastener comprising a shaft, fins axially spaced along the shaft, and a spine extending, perpendicular to the shaft's longitudinal axis, from the shaft. The push-pin rivet fastener is adapted for use with structural components, particularly structural components of vehicles.

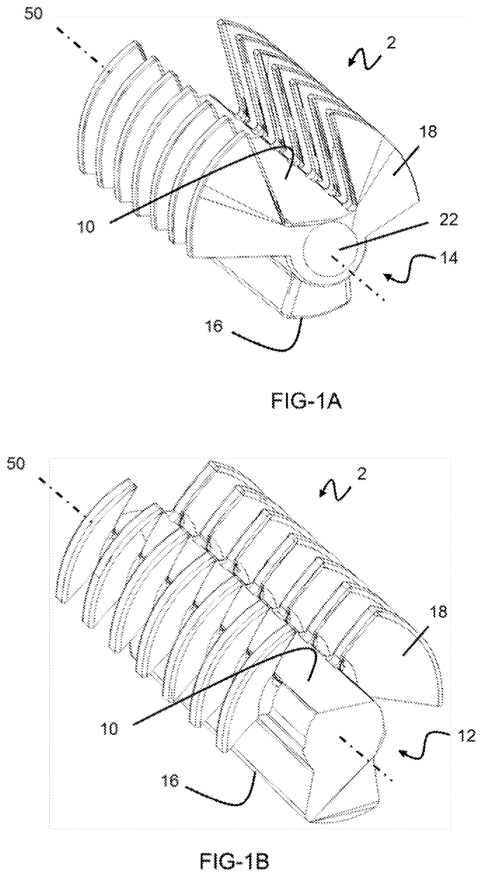

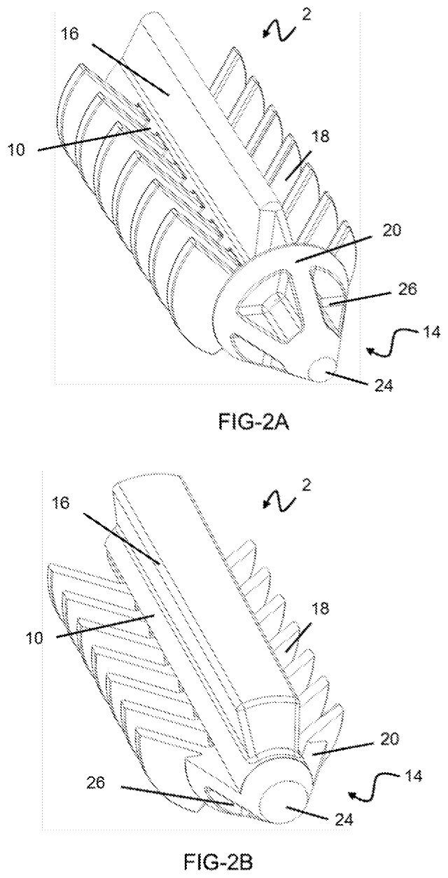

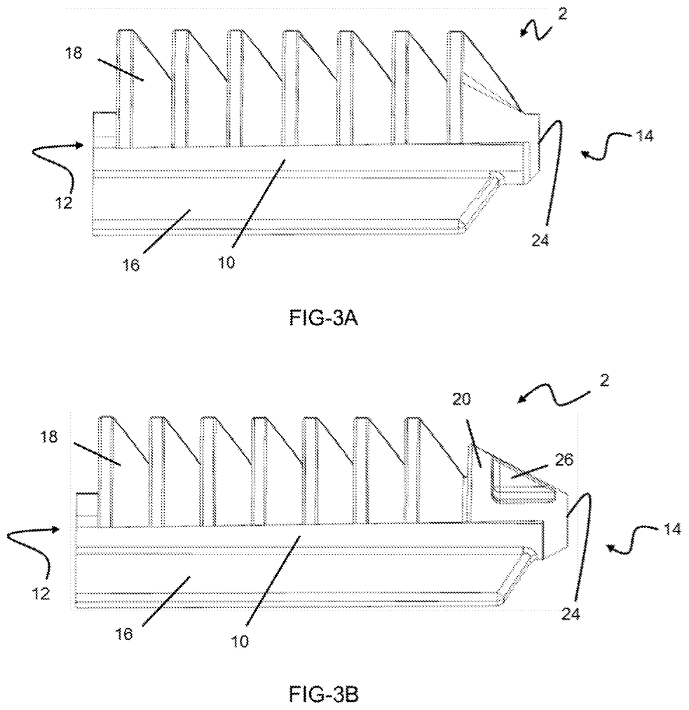

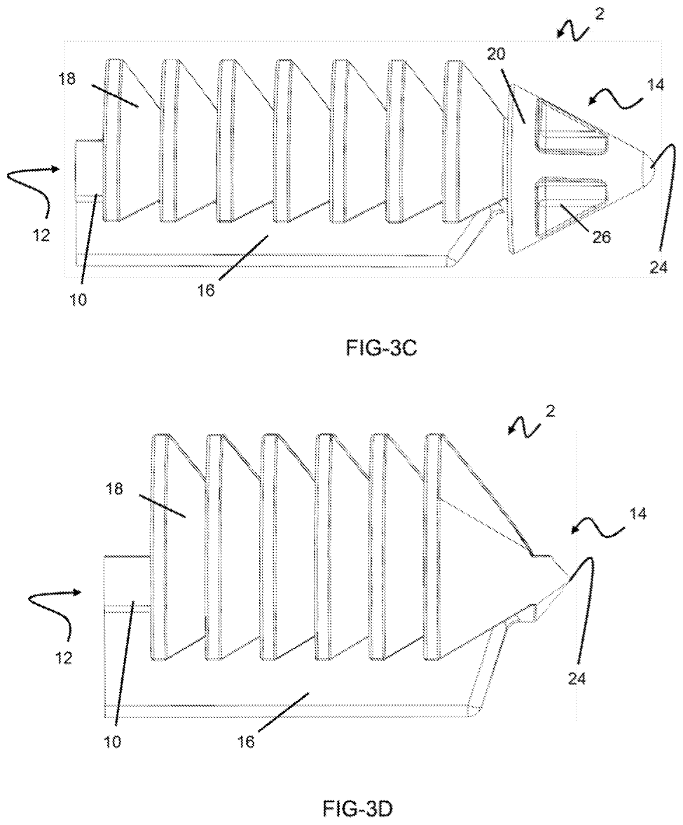

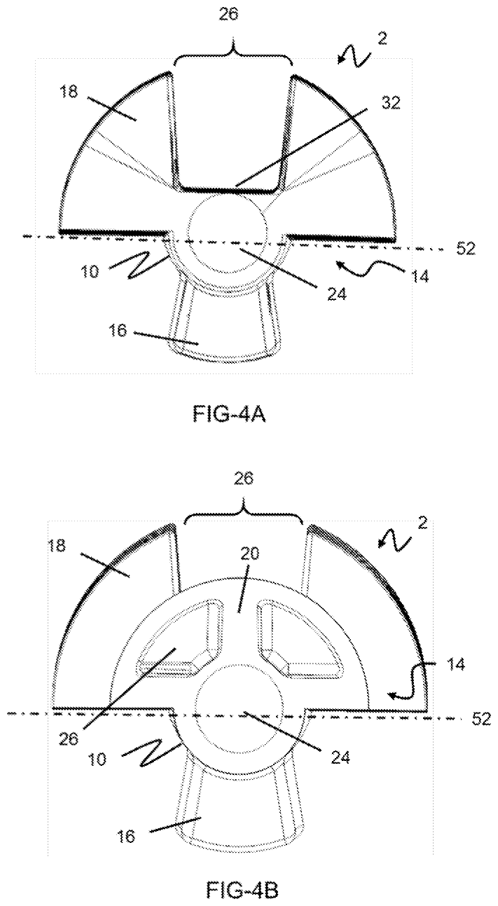

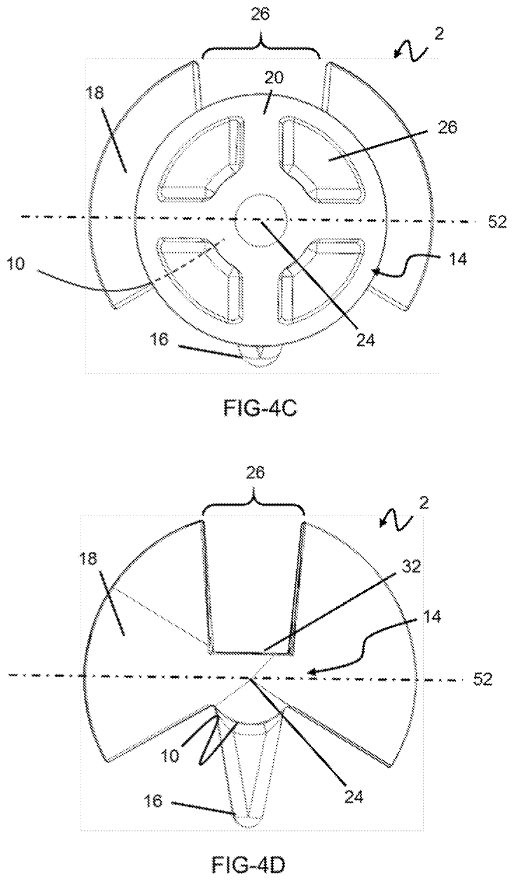

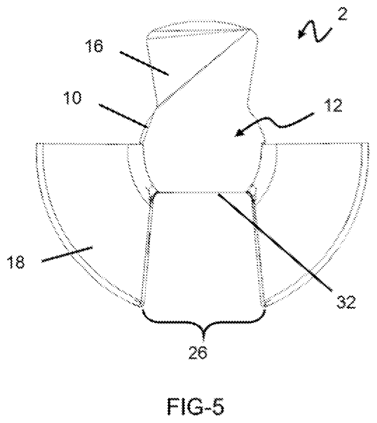

### FIELD

The present teachings generally relate to fasteners for use with structural components. More particularly, the present disclosure relates to fasteners of the push-pin rivet variety, for use with structural components.

### BACKGROUND

Some manufacturers are concerned with securely fastening together structural components, aesthetic components, or both. This concern is particularly held amongst manufacturers of vehicles, the structural components of which are subject to regular stress via vibrations generated from road conditions, wind resistance, impact, and deformations of adjacent components (e.g., flexion of a vehicle frame). An example of a fastener used in the construction of vehicles may be found in U.S. Pat. No. 4,392,278, which is incorporated herein for all purposes.

One concern that arises, particularly due to incessant vibrations exerted on both fastened components and fasteners, is the tendency for a fastener to back out of a fastened component. Some manufacturers are also concerned with reducing the costs of fasteners while maintaining the structural characteristics that the fasteners impart on the structural components. Also of concern is constructing fasteners that are compatible with or even improve the molding process. For example, the process of injection molding requires careful engineering of the workpiece to avoid the workpiece sticking in the mold and to promote predictable ejection of the workpiece from the mold.

It would be desirable to provide a fastener having a reduced tendency to back out of a fastened component.

It would be desirable to provide a fastener having reduced material while maintaining structural strength and durability.

It would be desirable to provide a fastener, the construction of which improves the molding process.

### SUMMARY

The present disclosure provides for a fastener of the push-pin rivet variety comprising: a shaft, fins axially spaced along the shaft on a first transverse cross-sectional half of the shaft, and a spine extending, perpendicular to the shaft's longitudinal axis, from the shaft, on a second transverse cross-sectional half of the shaft; wherein the fastener is configured to be accepted by a hole in an article; and wherein the spine is configured to bias the fins against an interior of the hole when the fastener is applied to the hole.

The fins may extend at an angle from the longitudinal axis of the shaft. The angle may be no less than 30 degrees from the longitudinal axis of the shaft and no more than 90 degrees from the longitudinal axis of the shaft. The fins may be conical in shape. The fins may be conical sectors defined by an angle. The angle may be no less than 10 degrees and no more than 120 degrees. The fins may be arranged in two rows extending along the longitudinal axis of the shaft, wherein the two rows exhibit reflection symmetry, wherein the reflection symmetry is defined by a plane of reflection extending through the longitudinal axis of the shaft. A notch may be formed in the shaft and the two rows. The notch may form a shelf in the transverse cross-section of the shaft, between the two rows. The fins may be arranged extending from a single transverse cross-sectional half of the shaft.

The spine may have a lateral extension substantially the same as a lateral extension of the fins. The fins may have a lateral extension configured to be substantially the same as or larger than a radius of the hole. The spine may taper to a point at the distal edge of the spine. The spine may enlarge toward the distal edge of the spine. The distal edge of the spine, viewed as a transverse cross-section of the spine, may comprise an arc defined by a radius that is configured to be substantially equal to or larger than a radius of the hole. The spine may be configured to be keyed to a mold. The keying of the spine to the mold may prevent deformation or early ejection of the fastener when an action of a slide, the mold, or both opens. The spine may have a taper from an interface of the spine with the shaft to the distal edge of the spine. The push-pin rivet may be used to fasten vehicle trim components. The spine may extend along substantially the length of the shaft.

The fastener may include a nose having a skirt, a tip, or both. The tip may be a point or a flat face. The skirt may include depressions. The depressions may strengthen the skirt on portions of the skirt where the depressions are disposed.

### BRIEF DESCRIPTION OF DRAWINGS

The features and inventive aspects of the present disclosure will become more apparent upon reading the following detailed description, claims, and drawings, of which the following is a brief description:

FIG.-1A illustrates a perspective view of the fastener.

FIG.-1B illustrates a perspective view of the fastener.

FIG.-2A illustrates a perspective view of the fastener.

FIG.-2B illustrates a perspective view of the fastener.

FIG.-3A illustrates a side view of the fastener.

FIG.-3B illustrates a side view of the fastener.

FIG.-3C illustrates a side view of the fastener.

FIG.-3D illustrates a side view of the fastener.

FIG.-4A illustrates a front view, along the longitudinal axis of the fastener.

FIG.-4B illustrates a front view, along the longitudinal axis of the fastener.

FIG.-4C illustrates a front view, along the longitudinal axis of the fastener.

FIG.-4D illustrates a front view, along the longitudinal axis of the fastener.

FIG.-5 illustrates a rear view, along the longitudinal axis of the fastener.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific examples of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing date of U.S. Provisional Application Ser. No. 62/756,352, filed Nov. 6, 2018, the contents of that application being hereby incorporated by reference herein for all purposes.

The present disclosure relates to fasteners used to couple together two or more fastened articles. The fastened articles may be structural elements. Particularly, the fastened articles may be structural elements of a vehicle, aesthetic elements of a vehicle, or a combination thereof. For example, a trim panel of a vehicle (i.e., aesthetic element) of a vehicle may be coupled to a vehicle frame (i.e., structural element). As another example, a structural reinforcement such as for a car bumper or perhaps a vehicle joint (i.e., structural element) may be coupled to a vehicle frame (i.e., structural element). The fastened articles may include holes, which are configured to align and accept a fastener. As referred to herein, “entry hole” may refer to the entry hole of one fastened article or the entry hole of the first (i.e., the fastened article that the fastener first passes through upon insertion) of a series of aligned fastened articles accepting a fastener. As referred to herein, “exit hole” may refer to the exit hole of one fastened article or the exit hole of the last (i.e., the fastened article that the fastener passes through last) of a series of aligned fastened articles accepting a fastener. As referred to herein, “rim” may refer to the surface of the fastened article immediately adjacent the hole. The holes may be blind holes (i.e., not extending fully through a fastened article) or through-holes (i.e., extending fully through a fastened article). All of the two or more fastened articles may have through-holes. The first fastened article may have a through-hole and the last fastened article may have a blind hole. The fastener used to couple the fastened articles are described below.

The fastener may function to couple two or more fastened articles together. The fastener may be of the push-pin rivet variety. As referred to herein, the terms “fastener” and “push-pin rivet” may be used interchangeably. The fastener may be removable or non-removable. Preferably, the fastener is non-removable (i.e., not removable without causing deformation, damage, or both to the fastener). The fastener may be configured to fit a hole formed in the two or more fastened articles. As referred to herein, “longitudinal axis” may refer to an axis arranged along the length of the fastener. As referred to herein, “transverse axis” may refer to an axis arranged perpendicular to the longitudinal axis. The fastener may be formed by a molding process. Preferably, the fastener is formed by compression molding or injection molding. The fastener may comprise one or more polymers. Particularly, the fastener may comprise nylon, PVC, polypropylene, phenolic, PTFE, acetal (e.g., Delrin®), polycarbonate, polypropylene, ABS, or the like. The polymer of the fastener may include additives to impart improved mechanical properties of the fastener. Particularly, the fastener may include glass fibers (e.g., “glass filled”) to impart rigidity, strength, or surface hardness to the fastener. The fastener may include a shaft, an end, a spine, fins, a nose, or a combination thereof, which are described with more particularity below.

The shaft may function as the integral supporting structure of the fastener to which the end, the nose, the spine, the fins, or a combination thereof are attached. The shaft may extend along the longitudinal axis of the fastener. The shaft may have a circular, ovate, elliptic, or polygon shaped transverse cross-section. Preferably, the shaft has a circular transverse cross-section, where the circular transverse cross-section may be a segmented circular transverse cross-section. The shaft may have a transverse cross-sectional length of 3 mm or more, 5 mm or more, 7 mm or more, 15 mm or less, 12 mm or less, or 9 mm or less. The shaft may have a length, along the fastener's longitudinal axis, of 2 cm or more, 4 cm or more, 6 cm or more, 16 cm or less, 14 cm or less, or even 12 cm or less. The shaft may have two ends located distally on the longitudinal axis of the fastener.

The tail may function as an interface for the fastener to be driven into place in the hole. The tail may be a distal end of the shaft. The tail may be with or without a head. Where the tail is without a head, the tail may be a flat or shaped surface of the distal end of the shaft, which may be configured to extend into the hole with no portion of the tail being exposed outside the hole. Where the tail is with a head, the head may be a pan head, a flat head, a truss head, a fillister head, or a washer head. The head may be configured to sit flush against the surface of the fastened article in order to prevent moisture or debris from entering the hole. Preferably, the tail may be a without a head.

The spine may function to bias the fins against the interior of the hole. The spine may be a structure extending perpendicular to the fastener's longitudinal axis, terminating at an edge distal from the shaft. The spine may extend, along the fastener's longitudinal axis, the full length of the shaft (i.e., from one distal end of the shaft to the other distal end of the shaft) or the spine may extend along only a portion of the length of the shaft. The spine may extend from a transverse cross-sectional half of the fastener that is opposite the transverse cross-sectional half of the fastener to which the fins are coupled. The height of the spine may substantially correspond to the radius of the hole, whereby the distance between the center of the fastener to the distal edge of the spine is substantially the same as the radius of the hole. The spine may taper to a point at the spine's distal edge or enlarge toward the spine's distal edge. Where the spine enlarges towards the spine's distal edge, the spine's distal edge (viewed as a transverse cross-section of the spine) bears an arc defined by a radius that is configured to be substantially equal to the radius of the hole. The spine may include a taper, from the interface of the spine with the shaft to the distal edge of the spine, having an angle biased away from the nose; wherein the taper may aid in guiding the fastener into the hole. The spine may be keyed in the mold (e.g., compression mold or ejection mold) to prevent deformation or early ejection when the action of the slide, the mold, or both opens.

The fins may function to bias against the hole, hook onto features of the hole (e.g., ribs, the rim of the exit hole, or the like), or both. The fins may have an axial spacing between one another. The axial spacing may be more than 1 mm, more than 2 mm, more than 3 mm, less than 7 mm, less than 6 mm, or less than 5 mm. The fins may be biased in a direction toward the tail. The fins may be deformable in a direction toward the tail. The fins may have a lateral extension (i.e., an extension perpendicular to the longitudinal axis of the fastener) of a length that is substantially equal to the diameter of the hole or larger than the diameter of the hole. Preferably, the length of the lateral extension is larger than the diameter of the hole, wherein upon insertion of the fastener in the hole the fins are deformed. There may be friction between the fins and the hole, wherein the friction may be a function of the differential between the lateral extension of the fins and the radius of the hole. The fins may be substantially conical in shape and exhibiting symmetry about a plane intersecting the longitudinal axis of the fastener. More particularly, the fins may be sectors of a cone (i.e., portions of a cone defined by an angle). The interface between the fins and the shaft may be defined by an angle centered to the center of the shaft. For example, fins extending an angle around the shaft bear an interface to the shaft that is an arc length around the shaft.

The nose may function to guide the fastener into the hole. The nose may be located on a distal end of the shaft that is opposite the tail. The nose may include a skirt, a tip, or both. The nose may pass through the hole (e.g., where the hole is a through-hole) or the nose may form a complimentary fit with the hole (e.g., where the hole is a blind hole).

The tip may be a point or a flat face. The point may be configured to form a complimentary fit within a tapered blind hole. The flat face may be configured to sit flush against a squared blind hole. The fastener having a flat face may be configured to sit substantially flush to the rim of a through-hole's exit.

The skirt may function to affix the fastener within the fastened article. The skirt may be a truncated cone (e.g., where the nose includes a flat faced tip) or a sector of a truncated cone having a diameter that tapers from the shaft end of the cone to the tip end of the cone. Where the skirt is a sector of a truncated cone, the skirt may be defined by an angle, wherein the angle may be 45 degrees or more, 90 degrees or more, 135 degrees or more, 270 degrees or less, 225 degrees or less, or 180 degrees or less. The widest transverse cross-sectional diameter of the skirt may be larger than the transverse cross-sectional diameter of the hole and the skirt may be deformable. The skirt may deform as it passes the entry of a through-hole, pass through an exit of the through-hole, return to a pre-deformed state, and brace against the rim of the exit hole. The skirt may be configured to be substantially non-removable (i.e., not removable unless in the case of the fastener being deformed, destroyed, or both). The skirt may have a lateral extension that is substantially the same as or smaller than the lateral extension of the fins. The skirt may include one or more depressions.

The depression may function to strengthen the skirt and reduce the amount of material used in forming the fastener. The depression may be a structure formed in the skirt, concave from the conical surface of the skirt. The depression may be one or more depressions distributed around the skirt. The angles between surfaces of the skirt, formed by the depression, may provide strength to the skirt (e.g., resistance to bending stress), wherein the increased strength of the skirt improves the fastener's resistance to being removed from the fastened article. The depression may only impart increased strength to the portion of the skirt spanned by the depression and accordingly, the depression may not interfere with the deformation of a portion of the skirt where the depression does not span.

The notch may function to assist in ejection of the fastener from a mold and reduce the amount of material used in forming the fastener. The notch may be a void between two series of fins. The notch may form a shelf in the shaft, where the shelf is a void of the transverse cross-sectional segment (i.e., segment of a circle) of the shaft.

FIG.-1A illustrates a perspective view of the fastener 2. The fastener 2 includes a shaft 10, fins 18, a spine 16, and a nose 14. The fastener 2 has a longitudinal axis 50 extending through the center of the cross-sectional length of the shaft 10 and extends along the length of the shaft 10. The fins 18 include two rows of fins 18, conical in shape, each of identical dimensions, and arranged in series along the shaft 10. The fins 18 extend laterally from the shaft 10 and at an angle from the shaft where the distal ends of the fins 18 are biased away from the nose 14. The interface of the fins 18 and the shaft 10 is located on a transverse cross-sectional half of the shaft 10. The spine 16 extends laterally from the shaft 10, perpendicular to the longitudinal axis 50 of the fastener 2. The spine 16 is coupled to the transverse cross-sectional half of the shaft 10 that opposes the fins 18. The nose 14 is distally coupled to the shaft 10. The nose 14 comprises a tip 24, which is a flat face.

FIG.-1B illustrates a perspective view of the fastener 2. The fastener 2 includes a shaft 10, fins 18, a spine 16, and a tail 12. The fastener 2 has a longitudinal axis 50 extending through the center of the transverse cross-sectional length of the shaft 10 and extends along the length of the shaft 10. The fins 18 include two rows of fins 18, conical in shape, each of identical dimensions, and arranged in series along the shaft 10. The fins 18 extend laterally from the shaft 10 and at an angle from the shaft where the distal ends of the fins 18 are biased toward the tail 12. The interface of the fins 18 and the shaft 10 is located on a first transverse cross-sectional half of the shaft 10. The spine 16 extends laterally from the shaft 10, perpendicular to the longitudinal axis 50 of the fastener 2. The spine 16 is coupled to a second transverse cross-sectional half of the shaft 10, that opposes the fins 18. The tail 12 is the distal end of the shaft 10. The tail 12 is a surface that is perpendicular to the longitudinal axis 50.

FIG.-2A illustrates a perspective view of the fastener 2. The fastener 2 includes fins 18, a shaft 10, a spine 16, and a nose 14. The fins 18 include two rows of fins 18, each of identical dimensions, and arranged in series along the shaft 10. The fins 18 are conical in shape. The fins 18 extend laterally from the shaft 10 and at an angle from the shaft where the distal ends of the fins 18 are biased away from the nose 14. The interface of the fins 18 and the shaft 10 extends between a first and a second transverse cross-sectional halves of the shaft 10. The spine 16 extends laterally from the shaft 10, perpendicular to the longitudinal axis 50 of the fastener 2. The spine 16 is coupled to a second transverse cross-sectional half of the shaft 10. The spine 16 extends a length along the transverse cross-sectional perimeter of the shaft 16. The transverse cross-section of the spine 16 tapers to a point at its distal edge. The nose 14 is distally coupled to the shaft 10. The nose 14 comprises a skirt 20 and a tip 24, which is a point. The skirt 20 includes depressions 26, which extends into the skirt 20 toward the shaft 10.

FIG.-2B illustrates a perspective view of the fastener 2. The fastener 2 includes fins 18, a shaft 10, a spine 16, and a nose 14. The fins 18 include two rows of fins 18, each of identical dimensions, and arranged in series along the shaft 10. The fins 18 are conical in shape. The fins 18 extend laterally from the shaft 10 and at an angle from the shaft where the distal ends of the fins 18 are biased away from the nose 14. The interface of the fins 18 and the shaft 10 is located on a first transverse cross-sectional half of the shaft 10. The spine 16 extends laterally from the shaft 10, perpendicular to the longitudinal axis 50 of the fastener 2. The spine 16 is coupled to a second transverse cross-sectional half of the shaft 10. The spine 16 extends a length along the transverse cross-sectional perimeter of the shaft 16. The transverse cross-section of the spine 16 enlarges toward its distal end. The nose 14 is distally coupled to the shaft 10. The nose 14 comprises a skirt 20 and a tip 24, which is a flat face. The skirt 20 is a conical segment defined by a first transverse cross-sectional half of the shaft 10, which is the same cross-sectional half upon which the fins 18 are attached. The skirt 20 includes depressions 26, which extend into the skirt toward the shaft 10.

FIG.-3A illustrates a side view of the fastener 2. The fastener 2 includes fins 18, a shaft 10, a spine 16, and a nose 14. The fins 18 are arranged in a series along the shaft 10 from nose 14 to tail 12 and each of the fins 18 are conical in shape and of identical dimensions. The fins 18 extend laterally from the shaft 10 and at an angle from the shaft where the distal ends of the fins 18 are biased away from the nose 14. The spine 16 extends laterally from the shaft 10, perpendicular to the longitudinal axis (not shown) of the fastener 2. The spine 16 is coupled to a first transverse cross-sectional half of the shaft 10 opposite the second transverse cross-sectional half of the shaft 10 to which the fins 18 are coupled to. The spine 16 extends a length along the shaft 10 from nose 14 to tail 12. The spine 16 extends a length along the transverse cross-sectional perimeter of the shaft 16. The distal longitudinal end of the spine 16 adjacent the tail 12 of the shaft 10 is flat. The distal longitudinal end of the spine 16 adjacent the nose 14 of the shaft 10 has a taper, from the interface of the spine with the shaft to the distal edge of the spine, having an angle biased away from the nose 14. The nose 14 is distally coupled to the shaft 10. The nose 14 comprises a tip 24, which is a flat face.

FIG.-3B illustrates a side view of the fastener 2. The fastener 2 includes fins 18, a shaft 10, a spine 16, and a nose 14. The fins 18 are arranged in a series along the shaft 10 from nose 14 to tail 12 and each of the fins 18 are conical in shape and of identical dimensions. The fins 18 extend laterally from the shaft 10 and at an angle from the shaft where the distal ends of the fins 18 are biased away from the nose 14. The spine 16 extends laterally from the shaft 10, perpendicular to the longitudinal axis (not shown) of the fastener 2. The spine 16 is coupled to a first transverse cross-sectional half of the shaft 10 opposite a second transverse cross-sectional half of the shaft to which the fins 18 are coupled to. The spine 16 extends a length along the transverse cross-sectional perimeter of the shaft 16. The distal longitudinal end of the spine 16 adjacent the tail 12 of the shaft 10 is flat. The distal longitudinal end of the spine 16 adjacent the nose 14 of the shaft 10 has a taper, from the interface of the spine with the shaft to the distal edge of the spine, having an angle biased away from the nose 14. The nose 14 is distally coupled to the shaft 10. The nose 14 comprises a skirt 20 and a tip 24, which is a flat face. The skirt 20 is a conical sector defined by a transverse cross-sectional half of the shaft 10. The skirt 20 includes depressions 26, which extend into the skirt 20 toward the shaft 10.

FIG.-3C illustrates a side view of the fastener 2. The fastener 2 includes fins 18, a shaft 10, a spine 16, and a nose 14. The fins 18 are arranged in a series along the shaft 10 from nose 14 to tail 12 and each of the fins 18 are conical in shape and of identical dimensions. The fins 18 extend laterally from the shaft 10 and at an angle from the shaft 10 where the distal ends of the fins 18 are biased away from the nose 14. The spine 16 extends laterally from the shaft 10, perpendicular to the longitudinal axis (not shown) of the fastener 2. The spine 16 is coupled to a first transverse cross-sectional half of the shaft 10 opposite a second transverse cross-sectional half of the shaft to which the fins 18 are coupled to. The spine 16 extends a length along the transverse cross-sectional perimeter of the shaft 16 from nose 14 to tail 24. The distal longitudinal end of the spine 16 adjacent the tail 12 of the shaft 10 is flat. The distal longitudinal end of the spine 16 adjacent the nose 14 of the shaft 10 has a taper, from the interface of the spine with the shaft to the distal edge of the spine, having an angle that is biased away from the nose 14. The nose 14 is distally coupled to the shaft 10. The nose 14 comprises a skirt 20 and a tip 24, which is a point. The skirt 20 is conical in shape. The skirt 20 includes depressions 26, which extend into the skirt 20 toward the shaft 10.

FIG.-3D illustrates a side view of the fastener 2. The fastener 2 includes fins 18, a shaft 10, a spine 16, and a nose 14. The fins 18 are arranged in a series along the shaft 10 from nose 14 to tail 12 and each of the fins 18 are conical in shape and of identical dimensions. The fins 18 extend laterally from the shaft 10 and at an angle from the shaft where the distal ends of the fins 18 are biased away from the nose 14. The spine 16 extends laterally from the shaft 10, perpendicular to the longitudinal axis (not shown) of the fastener 2. The spine 16 is coupled to a first transverse cross-sectional half of the shaft 10 opposite a second transverse cross-sectional half of the shaft to which the fins 18 are coupled to. The spine 16 extends a length along the transverse cross-sectional perimeter of the shaft 16. The distal longitudinal end of the spine 16 adjacent the tail 12 of the shaft 10 is flat. The distal longitudinal end of the spine 16 adjacent the nose 14 of the shaft 10 has a taper, from the interface of the spine with the shaft to the distal edge of the spine, having an angle that is biased away from the nose 14. The nose 14 is distally coupled to the shaft 10. The nose 14 comprises a tip 24, which is a point.

FIG.-4A illustrates a front view of the fastener 2, along the longitudinal axis (not shown) of the fastener 2. The fastener 2 includes fins 18, a shaft 10, a spine 16, a nose 14, and a transverse axis 52. The transverse axis 52 divides the transverse cross-section of the shaft 10 into two halves. Two sets of fins 18 extend laterally from a first transverse cross-sectional half of the shaft 10. The spine 16 extends laterally from a second transverse cross-sectional half of the shaft 10, perpendicular to the transverse axis 52. A notch 26 is a void defined by the two sets of fins 18 and a shelf 32 formed in the shaft 10. The nose 14 is distally coupled to the shaft 10. The nose 14 comprises a tip 24, which is a flat face.

FIG.-4B illustrates a front view of the fastener 2, along the longitudinal axis (not shown) of the fastener 2. The fastener 2 includes fins 18, a shaft 10, a spine 16, a nose 14, and a transverse axis 52. The transverse axis 52 divides the transverse cross-section of the shaft 10 into two halves. Two sets of fins 18 extend laterally from a first transverse cross-sectional half of the shaft 10. The spine 16 extends laterally from a second transverse cross-sectional half of the shaft 10, perpendicular to the transverse axis 52. A notch 26 is a void defined by the two sets of fins 18 and a shelf (not shown) formed in the shaft 10. The nose 14 is distally coupled to the shaft 10. The nose 14 comprises a skirt 20 and a tip 24, which is a flat face. The skirt 20 is a conical sector extending around the first transverse cross-sectional half of the shaft 10. The skirt 20 includes depressions 26, which extend into the skirt 20 toward the shaft 10.

FIG.-4C illustrates a front view of the fastener 2, along the longitudinal axis (not shown) of the fastener 2. The fastener 2 includes fins 18, a shaft 10, a spine 16, a nose 14, and a transverse axis 52. The transverse axis 52 divides the transverse cross-section of the shaft 10 into two halves. Two sets of fins 18 extend laterally from a first transverse cross-sectional half of the shaft 10. The spine 16 extends laterally from a second transverse cross-sectional half of the shaft 10, perpendicular to the transverse axis 52. A notch 26 is a void defined by the two sets of fins 18 and a shelf (not shown) formed in the shaft 10. The nose 14 comprises a skirt 20 and a tip 24, which is a point. The skirt 20 is conical in shape and extends around the perimeter of both transverse cross-sectional halves of the shaft 10. The skirt 20 includes depressions 26, which extend into the skirt 20 toward the shaft 10.

FIG.-4D illustrates a front view of the fastener 2, along the longitudinal axis (not shown) of the fastener 2. The fastener 2 includes fins 18, a shaft 10, a spine 16, a nose 14, and a transverse axis 52. The transverse axis 52 divides the transverse cross-section of the shaft 10 into two halves. Two sets of fins 18 extend laterally from a first transverse cross-sectional half of the shaft 10. The spine 16 extends laterally from a second transverse cross-sectional half of the shaft 10, perpendicular to the transverse axis 52. A notch 26 is a void defined by the two sets of fins 18 and a shelf 32 formed in the shaft 10. The nose 14 is distally coupled to the shaft 10. The nose 14 comprises a tip 24, which is a point.

FIG.-5 illustrates a rear view of the fastener 2, along the longitudinal axis (not shown) of the fastener 2. The fastener 2 includes fins 18, a shaft 10, a spine 16, and an tail 12. A notch 26 is a void defined by the two sets of fins 18 and a shelf 32 formed in the shaft 10.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, from 20 to 80, or even from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates examples that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A fastener of the push-pin rivet variety comprising:
a. a shaft,
b. fins axially spaced along the shaft on a first transverse cross-sectional half of the shaft, and
c. a spine extending, perpendicular to the shaft's longitudinal axis, from the shaft, on a second transverse cross-sectional half of the shaft;
wherein the fastener is configured to be accepted by a hole in an article; and
wherein the spine is configured to bias the fins against an interior of the hole when the fastener is applied to the hole.

2. The fastener of claim 1, wherein the fins extend at an angle from the longitudinal axis of the shaft; wherein the angle is no less than 30 degrees from the longitudinal axis of the shaft and no more than 90 degrees from the longitudinal axis of the shaft.

3. The fastener of any of claim 1, wherein the fins are conical in shape.

4. The fastener of claim 3, wherein the fins are conical sectors defined by an angle; wherein the angle is no less than 10 degrees and no more than 120 degrees.

5. The fastener of claim 1, wherein the fins are arranged in two rows extending along the longitudinal axis of the shaft, wherein the two rows exhibit reflection symmetry, wherein the reflection symmetry is defined by a plane of reflection extending through the longitudinal axis of the shaft.

6. The fastener of claim 5, wherein a notch is formed in the shaft and the two rows.

7. The fastener of claim 6, wherein the notch is forms a shelf in the transverse cross-section of the shaft, between the two rows.

8. The fastener of claim 1, wherein the fins are arranged extending from a single transverse cross-sectional half of the shaft.

9. The fastener of claim 8, wherein the spine has a lateral extension substantially the same as a lateral extension of the fins.

10. The fastener of claim 2, wherein the fins have a lateral extension configured to be substantially the same as or larger than a radius of the hole.

11. The fastener of claim 10, wherein the spine tapers to a point at the distal edge of the spine.

12. The fastener of claim 2, wherein the spine enlarges toward the distal edge of the spine.

13. The fastener of claim 12, wherein the distal edge of the spine, viewed as a transverse cross-section of the spine, comprises an arc defined by a radius that is configured to be substantially equal to or larger than a radius of the hole.

14. The fastener of claim 1, wherein the spine is configured to be keyed to a mold; wherein the keying of the spine to the mold prevents deformation or early ejection of the fastener when an action of a slide, the mold, or both opens.

15. The fastener of claim 2, wherein the spine has a taper from an interface of the spine with the shaft to the distal edge of the spine.

16. The fastener of claim 1, wherein the push-pin rivet is used to fasten vehicle trim components.

17. The fastener of claim 6, wherein the spine extends along substantially the length of the shaft.

18. The fastener of claim 1, wherein the fastener includes a nose having a skirt, a tip, or both.

19. The fastener of claim 18, wherein the tip is a point or a flat face.

20. The fastener of claim 18, wherein the skirt includes depressions; wherein the depressions strengthen the skirt on portions of the skirt where the depressions are disposed.
